(19) United States
(12) Patent Application Publication
(10) Pub. No.: US 2006/0075826 A1
(43) Pub. Date: Apr. 13, 2006

(54) Synthetic cortical bone for ballistic testing

(76) Inventors: Jack C. Roberts, Columbia, MD (US); Paul J. Biermann, Columbia, MD (US); Keith S. Caruso, Catonsville, MD (US); Gary E. Peck, Baltimore, MD (US)

Correspondence Address: APPLIED PHYSICS LABORATORY;THE JOHNS HOPKINS UNIVERSITY, OFFICE OF PATENT COUNSEL, 11100 JOHNS HOPKINS ROAD, LAUREL, MD, 20723-6099, US

(21) Appl. No.: 11/121,532

(22) Filed: May 4, 2005

Related U.S. Application Data
(60) Provisional application No. 60/568,210, filed on May 5, 2004.

(51) Int. Cl. G01N 3/00

(52) U.S. Cl. 73/788

(57) ABSTRACT

A bone substitute for use in impact testing of a structure simulating the human body which includes a member fabricated from epoxy resin and having a lengthwise dimension, and a fiberglass sheath embedded in an outer circumferential portion of the member, the sheath having glass fibers oriented along the length of the member.

### CROSS REFERENCE TO RELATED APPLICATIONS

This application claims the benefit of prior filed co-pending U.S. application No. 60/568,210, filed on May 5, 2004, the contents of which are incorporated by reference herein.

### STATEMENT OF GOVERNMENTAL INTEREST

This invention was made with Government support under Contract Nos. N00024-03-D-6606 and N00024-98-D-8124 awarded by the U.S. Navy. The Government has certain rights in the invention.

### BACKGROUND OF THE INVENTION

1. Field of the Invention

The present invention generally relates to substitutes for bone, and particularly to a bone substitute having mechanical properties relatively similar to that of human bone.

2. Description of the Related Art

Generally, bone tissue is a composite structure which has the ability to withstand compressive and tensile stresses, as well as bending and torsional movements. Hydroxyapatite (HA) crystals, arrayed in a protein matrix, allow bone to resist compression. However, this inorganic phase of bone has limited ability to withstand tensile or bending loads. Collagen fibrils organized into lamellae, analogous to steel reinforcements in concrete, help bone resist tensile and bending stresses.

Unfortunately, there is a shortage of human bone tissue on which to practice new techniques and procedures, and for testing. Cadaver bone is difficult and often expensive to obtain and is a serious potential biohazard. Therefore, bone substitutes are needed.

For example, U.S. Pat. No. 6,471,519 B1 discloses a bone substitute that drills ands cuts like bone for use in training and testing. The bone substitute disclosed in the '519 patent includes an inner core of foamable material or other soft material and an outer shell of a polymer such as epoxy resin with a particulate filler such as aluminum oxide or silicon carbide added thereto together with, in some cases, titanium oxide to form a slurry for casting or molding around the inner core.

Widely used composites for bone implant material include poly(etheretherketone), i.e., “PEEK”, with a filler of HA, carbon fiber, or E-glass fibers. Addition of HA to PEEK increases the tensile modulus, but reduces the strength and strain to fracture. Addition of HA in excess of 30% produces a material having similar tensile modulus to human cortical bone, but with reduced strength and strain to fracture. Composites made of PEEK with carbon fiber or E-glass reinforcing agent exhibit a stiffness similar to that of human bone, thereby reducing the stress shielding effects which can cause infections, non-union and refractures.

Accordingly, a suitable bone substitute is still needed, for example, in ballistic and blast testing in order to understand the types of injuries that can occur under ballistic impact or a blast upon a human torso. The bone substitute for such testing would have to have mechanical properties such as, for example, stiffness (Young's Modulus), tensile strength, and fracture toughness similar to that of human bone tissue. These properties govern the response of the bone structure (e.g., a rib cage) to impact loads. Bone is known to act as a viscoelastic material and its properties are significantly affected by deformation rate. Human cortical bone is anisotropic due to its complex structure including solid material, primary and secondary osteons, plexiform interstitial bone, collagen fiber lamellae and collagen fiber-mineral composites.

While PEEK composites have similar stiffness to bone and have been shown to be effective as bone implant materials, the requirements for bone implants and bone substitutes for impact testing are not altogether the same. For example, bone implants are engineered to match bone stiffness so as to eliminate the stress shielding effect of harder materials. But the strength and fracture toughness of implants do not have to match human bone as long as the implants are relatively strong and resist fracture under typical loading conditions of the bone or joint. Published results on PEEK composites with HA or carbon fibers do not indicate fracture strength similar to cortical bone. Matching all of the pertinent mechanical properties of stiffness, strength and fracture properties is of critical importance for a material used, for example, to make rib cages, vertebrae and sternums for HSTM models subject to ballistic testing. Thus, a need for a suitable bone substitute remains which reacts in a manner similar to human bone under, for example, high impact loads from ballistic projectiles or pressure waves from an explosive blast.

### SUMMARY OF THE INVENTION

A bone substitute for use in impact testing of a structure simulating the human body is provided herein. The bone substitute comprises a member fabricated from epoxy resin and a fiberglass sheath embedded in an outer circumferential portion of the member.

### BRIEF DESCRIPTION OF THE DRAWINGS

Various embodiments are described below with reference to the drawings wherein:

FIG. 1 is a schematic drawing of a model of a human torso for ballistics testing and re-enactment;

FIG. 2 is a sectional view illustrating a rib;

FIG. 3 illustrates a model rib with diagrammatic cross-sections of hollow and solid embodiments;

FIG. 4 is a graph illustrating stress/strain behavior of bone substitute materials in three-point-bending testing;

FIG. 5 is a graph illustrating stress/strain behavior of bone substitute materials in compression testing; and,

FIG. 6 is a graph illustrating load/displacement behavior of bone substitute materials in fracture toughness testing.

### DETAILED DESCRIPTION OF PREFERRED EMBODIMENT(S)

The bone substitute material of the present invention comprises a member fabricated from an epoxy resin, preferably with a fiberglass reinforcing agent. The member is easily fabricated by pouring the epoxy resin into silicone molds and curing. Simulated bone structures fabricated from the epoxy resin are advantageously used to construct models of the human body for use in ballistic or other impact testing.

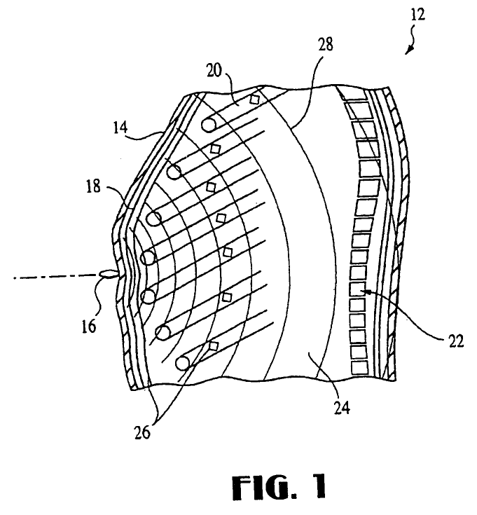

FIG. 1 is a schematic drawing of a suitable model of a human torso designed for ballistics testing and reenactment. The embodiment is an instrumented torso 12 designed to “wear” body armor 14 and record various forces, accelerations, translations and damage affecting the torso 12 when the armor 14 is impacted with a bullet 16 fired at a testing facility. The simulated shock waves 28 shown in the drawing illustrate how the stress, shock and shear waves related to Behind Armor Blunt Trauma radiate outward from a bullet's point of impact. The embodiment of the present invention shown in FIG. 1 includes a skin 18 and internal soft tissue 24 made of a flexible polymer such as polyurethane or silicone, and ribs 20, sternum and vertebrae 22 made of the bone substitute of the present invention that exhibits bone-like properties such as stiffness, brittleness and fracture toughness. For use in the present invention, the epoxy resin may be modified to increase tensile and bending strength to match that of bone by adding glass fiber or other fiber reinforcements.

Because the bone substitutes behave like bone on a local scale (e.g., sub-millimeter scale), the substitutes are able to actually fracture and splinter under conditions that would also break real human bones inside a living person. This feature is different from other bone substitutes, such as the steel ribs used in vehicle crash test dummies, that are designed to simulate real bones only on a macro scale. For example, steel ribs on a crash test dummy may be used to effectively simulate the kinematic motion of the test crash dummy during a vehicle crash, but could not be used effectively to simulate local bone damage caused by a bullet.

The skin 18 and soft tissue 24 substitutes may be formed from polymers exhibiting the mechanical properties that approximate those found in the body. Elastomeric polymers such as polyurethane and silicone are well suited for this, in particular those materials with a Shore A hardness <about 60, a Young's modulus (E) <about 900.0 psi or about 6.20⁻³ MPa, and a density between about 1.00⁻⁶ and about 1.30⁻⁶ g/mm³. Polyurethanes offer lower material costs and simple processing. Silicones offer better mechanical durability, ultraviolet resistance and better overall material stability. A large number of resin systems in both families have been tailored for use in the make-up and special effects fields to simulate biological materials, and in the medical prosthetics field for devices that allow people to cover missing or deformed portions of their body. These include nose, ear, jaw, eye-socket, fingers, hand, feet, toes, upper and lower limbs. The prosthetic applications typically need to mimic only the visual aspects of the item being replaced, but some mechanical behavior similarity is useful. For movie or theatrical make-up and special effects, the materials frequently must behave in a believable manner when mechanically loaded, and these materials are designed with that in mind. Additional materials can be used, but their processing may be more complex and the material properties more difficult to tune for the required mechanical response. These include, but are not limited to, rubber made from latex, butyl, neoprene, nitrile and gum base resins. Also, thermoplastic resins such as vinyl, nylon, polyethylene, and the whole range of thermoplastic elastomers could be used, but require a large investment in tooling for injection molding or transfer molding.

The simulated human tissue 24 is placed inside the thoracic cavity of the torso 12 and around the ribs 20 and vertebrae 22. The simulated tissue 24 may also include materials of various densities to simulate specific organs. For example, the liver is particularly vulnerable to Behind Armor Blunt Trauma and is subject to tearing under the extreme stress of the shear waves that can bounce back and forth inside the thoracic cavity. Therefore the designers of body armor should pay special attention to the protection of the liver. Clearly other organs such as the heart (specifically the aorta and aortic arch) and lungs may also require special instrumented modeling in some embodiments of the present invention.

Finally, several sensor arrays 26 are positioned on and inside of the torso 12. The sensor arrays 26 may include many different types of sensors to help develop a clear understanding of how a physical impact against the torso 12 creates forces, accelerations, translations, and damage concerning the different parts of the torso 12. Any type of sensor may be used, provided of course that it is capable of operating at the frequencies induced by the test incident. A bullet impacting a bulletproof vest can create standing waves inside the body near about 1 to about 2 KHz. As an example, piezoelectric accelerometers and resistive strain gages may be bonded to the simulated bone elements such as the ribs 20 and vertebrae 22. From the resistive gages bending stresses in the ribs can be measured and accelerations of the skeletal structure can assist in determination of the overall mechanical response of the torso.

Strain gages attached to the simulated bone could provide useful information concerning whether the bone fractures due to impact. Damage to organs and tissue may also be estimated based on data from accelerometers or resistive grids encapsulated in low durometer polymers that are then mechanically coupled to the simulated organs and tissue. Piezoelectric and resistive flexure sensor grids placed in various planes of the torso 12 may also be useful, such as in a plane perpendicular to the direction of the bullet inside the simulated tissue 24 for measuring the wave forces that pass through the tissue 24. In one embodiment, the sensor array can be cast into a layer of ballistic gelatin positioned between under the fat and skin layers.

More specifically, in a preferred embodiment, the bone substitute includes a member fabricated from an epoxy resin and having a sheath of fiberglass embedded in an outer circumferential portion of the member. The sheath is preferably braided with fibers oriented along the length of the member.

The member can be fabricated by casting epoxy resin in a silicone mold to conform to the configuration and dimensions of a human bone such as a rib, sternum, vertebrae, or other type bone.

In a preferred method of making the bone substitute, an epoxy resin is poured into a silicone rubber mold along with a curing agent. After the member is cured, a biaxial sleeve of woven or braided fiberglass is disposed around the member and pressed into the epoxy. The outside of the member is then coated with more epoxy and cured, thereby embedding the sleeve in the outer circumferential portion of the member.

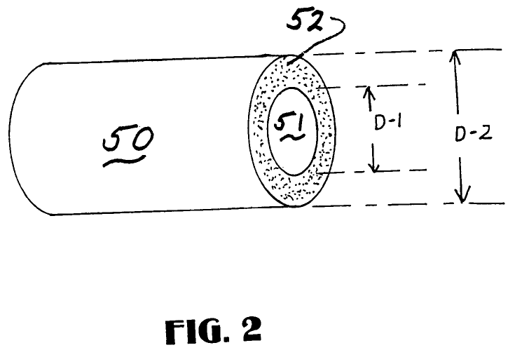

Referring now of FIG. 2, an embodiment of a substitute bone member 50 is illustrated which comprises an inner core 51 of neat epoxy resin and an outer circumferential portion 52 with fiberglass sheath embedded therein. The outer circumferential portion 52 closely approximates the relevant mechanical properties of cortical bone. The inner core 51 has a diameter D-1 typically ranging from about 0.09 inches to about 0.15 inches. The exterior diameter of the member D-2 typically ranges from about 0.25 inches to about 0.35 inches. The ratio of (D-1)/(D-2) typically ranges from about 0.35 to about 0.50. These ranges are given for illustrative purposes only. Bone substitutes dimensioned outside of these ranges can be employed when appropriate. Moreover, the cross-section of the bone substitute member can be circular, elliptical, square, rectangular, triangular or any other suitable configuration.

Epoxy resins suitable for use in the invention can be those which are commercially available under, for example, the designations EPON® Resins 815, 826 and 862 from Shell Chemical Co.

Determining the suitability of a material for use as a bone substitute for the purposes described herein comprises determining at least the bending strength and fracture toughness of the material. These properties are highly important selection criteria for obtaining a bone substitute which acts like real human bone upon impact. The bending strength and fracture toughness of the material are then compared with the predetermined corresponding properties of human bone. The bending strength and fracture toughness of the target material should be at least within about ±20% of the corresponding values for human bone. Table 1 below sets forth typical properties of human cortical bone (from cadavers) at lower strain rates taken from various published sources. Generally, the age of the person affects the mechanical properties of the bone.

TABLE 1
Published Properties of Human Cortical Bone at Lower Strain Rates (10⁻⁴ to 5 s⁻¹)

| Cadaveric | | | | | | | Fracture Toughness | |
|---|---|---|---|---|---|---|---|---|
| Age of Samples | Young's Modulus (GPa) | | | Strength (MPa) | | | (MPa-m^{1/2}) | |
| (years) | Bending | Tension | Compression | Bending | Tension | Compression | Bending | Tension |
| 61-71 | 10.0 | * | * | 133.1 | * | * | * | * |
| 35 | 15.2 | * | * | 165.5 | * | * | 6.5 | * |
| 60 | 14.2 | * | * | 152.2 | * | * | 5.8 | * |
| 90 | 13.0 | * | * | 135.0 | * | * | 5.1 | * |
| * | 1.2 | * | * | 106.2 | * | * | * | * |
| 46 | 11.2 | * | * | 200.0 | * | * | * | * |
| 66 | 12.6 | * | * | 188.0 | * | * | * | * |
| 27 | * | * | * | 165.0 | * | * | * | * |
| 55 | * | * | * | 110.0 | * | * | * | * |
| 80 | * | * | * | 80.0 | * | * | * | * |
| * | * | * | * | * | 106.0 | * | * | * |
| * | * | 12.7 | 11.7 | * | 132.6 | 204.6 | * | * |
| 66-69 | * | * | * | * | * | * | * | 4.3 |
| 59 | * | * | * | * | * | * | * | 2.1 |
| 27 | * | * | * | * | * | * | * | 4.5 |
| 27 | * | * | * | * | * | * | * | 4.0 |

Target mechanical properties for the bone substitute were taken from existing data on the youngest cadaveric bone tested. Also, for a rib cage being compressed during ballistic impact and blast, individuals ribs incur a bending moment. Therefore, published results from bending tests were considered over those from tension of compression. Using these criteria, 13.2 GPa and 176 MPa were chosen as baseline values for modulus and strength, respectively, of the synthetic bone. The target value for fracture toughness was chosen to be 6.5 MPa-m^{1/2}.

Human cortical bone is anisotropic due to is complex structure which includes the following entities listed in order of decreasing size: solid material, primary and secondary osteons, plexiform intertitial bone, collagen fiber lamellae, and collagen fiber-mineral composites.

The epoxy and epoxy-fiberglass composite materials herein are also anisotropic due to the nature of polymer materials, milled fiberglass strands randomly oriented in the epoxy volume, and the fiberglass sleeve added to the outside of some samples. Since both human bone and the synthetic bond replacements are anisotropic, it is important to consider properties of interest under the appropriate loading scheme. For this reason, in the examples below, three-point bending and compression tests of the synthetic bone were directly compared to similar test results in the published literature. The most important human bone properties to match in the rib cage of the human surrogate torso model (“HSTM”) are stiffness, strength, and fracture toughness in bending. Despite its complex structure, human bone can be considered homogeneous if the different components are assumed to be distributed uniformly throughout. The synthetic bone materials can also be considered homogeneous in many respects. Care was taken to thoroughly mix the resin and hardener creating homogeneity. Milled fiberglass was assumed to be uniformly distributed in the epoxy volume, although considerably greater effort would be needed to statistically evaluate the distribution and orientation of the fibers. The fiberglass braided sleeves were assumed to be uniform along the length of each sample.

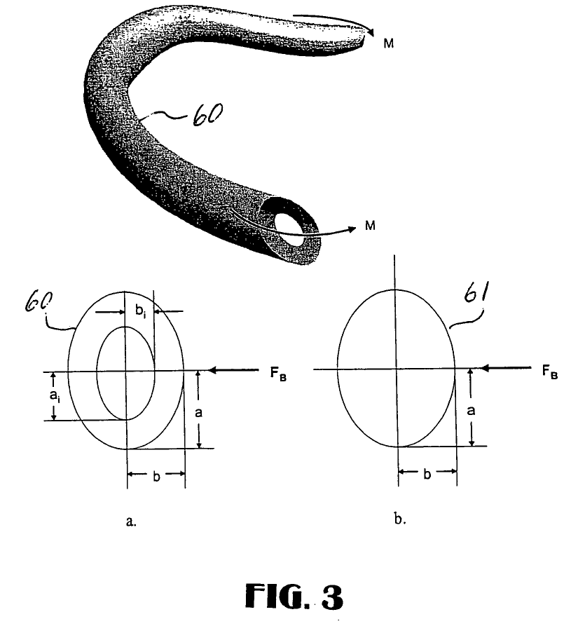

For ease of manufacturing the ribs in the HSTM were designed with a solid cross-section. Human ribs have a composite cross-section of spongy trabecular bone surrounded by harder cortical bone. Cortical bone generally has a porosity of about 5 to about 15%. Whereas trabecular bone porosity can range from about 40 to about 95%. A compressive strength of about 1.9 MPa and a compressive modulus of about 88 MPa has been reported for trabecular bone. These values are about 2 orders-of-magnitude lower than the strength and modulus of cortical bone. Therefore, human ribs were assumed to be hollow for the purposes of this study. Since HSTM ribs are solid and human ribs are considered hollow, target bone properties extracted from the literature must be scaled to make HSTM ribs that will be mechanically similar to human ribs in ballistic testing. Human and HSTM ribs both have irregular cross-sections, but are assumed elliptical for ease of calculating scaling factors. Equation (1) states the condition for a solid ellipse to match the bending strength and Young's modulus of a hollow ellipse with the same external dimensions. This condition is dependent solely on the moments of inertia for solid (ab³) and hollow (ab³-aᵢbᵢ³) ellipses with the bending force acting in the direction of the minor axis. FIG. 3 shows a model rib 60 having a hollow and elliptical cross-section used for scaling calculations. M represents the bending movement. F_{B} represents a bending force applied to the rib. Rib 61 is a solid rib.

$$\frac{{σ}_{HOLLOW BENDING}}{{σ}_{SOLID BENDING}} = \frac{{E}_{HOLLOW , BENDING}}{{E}_{SOLID , BENDING}} = \frac{( {ab}^{3} - {a}_{i} {b}_{i}^{3} )}{{ab}^{3}} , \qquad ( 1 )$$

a, b, aᵢ and bᵢ are ellipse dimensions shown in FIG. 3.

For comparison to the Young's modulus determined with bending tests, samples were also tested in compression. The target value for ribs of solid cross-section was calculated by scaling published data for human ribs using the ratio of cross-sectional areas of hollow to solid as described in equation (2).

$$\frac{{E}_{HOLLOW , COMPRESSION}}{{E}_{SOLID , COMPRESSION}} = \frac{( ab - {a}_{i} {b}_{i} )}{ab} \qquad ( 2 )$$

Using an average rib half height of 7.23 mm, average half width of 2.79 mm, and an average wall thickness of 0.89 mm, σ_{HOLLOW,BENDING}/σ_{SOLID,BENDING}=E_{HOLLOW,BENDING}/E_{SOLID,BENDING}=0.72 and E_{HOLLOW,COMPRESS}/E_{SOLID,COMPRESSION}=0.40. Therefore, the desired properties of the bone substitute were determined to be about 9.5 GPa for bending modulus (scaled from about 13.2 GPa), about 5.3 GPa for compression modulus (scaled from about 13.2 GPa), about 126.7 MPa for bending strength (scaled from about 176 MPa), and about 6.5 MPa-m^{1/2} for fracture toughness (unchanged by scaling considerations). These target values are indicated in Table 2 below. To reach these goals, development efforts focused on using a readily available epoxy system and improving its properties by using fiberglass additives to strengthen, toughen, and stiffen.

### EXAMPLES

All samples for mechanical testing were made by pouring epoxy made of EPON 862 resin and Epikure 3274 curing agent (100/40 mix ratio by weight) into rubber molds. For preparing the test samples, molds of cylindrical and rectangular cross-section were sized to conform at ASTM testing standards and to be representative of rib dimensions. This epoxy was used because the constituents are readily available and are typically used to make encapsulation and casting compounds of high stiffness and strength. EPON 862 is a low viscosity Bisphenol F resin that handles and flows well at room temperature and wets well to fibers and fillers. Epikure 3174 is an aliphatic amine curing agent with low viscosity, low volatility, long working time and relatively rapid room temperature cure. Samples prepared and tested include neat epoxy, epoxy with milled fiberglass (Fibre Glast Developments Corporation, 0.8 mm length) in volume, and epoxy with a 19 mm ID biaxial fiberglass±45° braided sleeve (A&P Technology Silasox, 12.3 oz/yd²) embedded at the outside of the samples. A titanate (Kenrich Petroleium KR-55, 1% by weight) and glass microspheres (0.5% by weight) were added to the mix to suspend the milled fiberglass in the epoxy as uniformly as possible. The epoxy was hand mixed at ambient temperature until even consistency and even coloring were attained with visual inspection. The sides and bottom of the container were scraped several times to ensure a homogeneous blend. A reasonable amount of time is needed to pour the mixtures into the rib, vertebrae, and sternum molds. Therefore, processing steps were chosen to extend the working time of the adhesive as much as possible. Warming the epoxy would shorten its working time as would mechanical mixing which adds excess air to the system, making the degas time longer. The epoxy mixture was degassed after the resin and hardener were blended. Mixtures with milled fiberglass were degassed a second time after the fiberglass was mixed into the epoxy. Samples with the biaxial fiberglass sleeve were made by curing neat epoxy samples for one day, pulling the sleeve around the outside and pressing it into the epoxy, then coating the outside of the samples with epoxy thus embedding the sleeve. All samples of the bone substitute were cured at 25° C. for 7 days before testing.

The material is used to make rib cages, vertebrae and sternums for HSTM physical models subject to ballistic testing. It is important in this testing to have realistic stiffness, strength, and fracture properties to study the physical effects of ballistic impacts on the torso. Particularly important are the bending strength and fracture toughness. An epoxy composite was also favored because of cost effectiveness and ease of manufacturing. Pouring epoxy into silicone molds is much easier and cheaper than processing thermoplastics to make the same parts. Constructing molds for curing thermoplastics is cost effective only if the parts are mass-produced. Ribs and vertebrae for the HSTM models are presently made in only small quantities.

Mechanical tests of the synthetic bone materials were conducted in accordance with ASTM standards for bending, fracture toughness, and compression of plastics. All sample sizes were chosen to be somewhat representative of rib size, while adhering as closely as possible to ASTM sample dimensions and aspect ratios. For each material type and test method, 6 tests were performed to allow for statistical distribution of results. All mechanical tests were performed on a universal servo-mechanical load frame with a 29 kN load cell having an accuracy of 0.1% full scale. Load cell output (N) and load frame crosshead displacement (mm) were continually recorded during each test.

Sample testing for strength and stiffness was performed in three-point-bending per ASTM Standard D790-03 (Standard test Methods for Flexural Properties of Unreinforced and Reinforced Plastics and Electrical Insulating Materials). Rectangular cross-section bending samples were loaded at a crosshead displacement rate of 1.3 mm/min (strain rate 3×10⁻⁴ s⁻¹). For samples with the biaxial fiberglass sleeve, the sleeve was oriented lengthwise around the outside of the bar and had a ±45° weave direction relative to the specimen longitudinal axis. Samples were simply supported by steel pins of diameter 3.2 mm, the loading nose was a steel pin of diameter 6.4 mm. The span length between support pins 5018 mm and average sample length±one standard deviation was 63.5±1.025 mm, allowing for 10% overhang. Samples of neat EPON 862/Epikure 3174 epoxy and epoxy with milled fiberglass in volume had an approximate span-to-width ratio of 4:1 and span-to-thickness ratio of 8:1. The 19 mm fiberglass biaxial sleeve on the outside of some samples increased the width and thickness of test bars by approximately 30%, resulting in span-to-width and span-to-thickness ratios of 3:1 and 6:1. Stress, strain, and Young's modulus of the synthetic bone materials in bending were calculated using elastic beam theory equations applied to load and displacement characteristics of each test sample. Maximum flexural stress in the outer surface of the test specimen occurs at the midspan and is calculated from load and sample dimensions by using equation (3). The flexural strain or nominal fractional change in the length of an elements of the outer surface of the specimen at midspan is given by equation (4) in terms of the midsppan deflection and sample dimensions. Young's modulus is the ratio of stress to strain in equation (5). Young's modulus was calculated from test data as the least square fit of stress vs. strain data in the linear range. P is the force exerted on the specimen at midspan, A is the related applied displacement, L is the support span length, w is the sample width and t is the sample thickness.

$$\begin{matrix}σ = \frac{3 PL}{2 {wt}^{2}} & ( 3 ) \\ ɛ = \frac{6 Δ t}{{L}^{2}} & ( 4 ) \\ E = \frac{σ}{ɛ} = \frac{{PL}^{3}}{4 Δ {wt}^{3}} & ( 5 )\end{matrix}$$

Bone exhibits significant plastic behavior and can be modeled as an elastic perfectly plastic material. Ultimate load in bending can be twice as high as in tension for human cortical bone. This disparity can be accounted for by considering plastic behavior of bone after yield. If the ratio of elastic elongation to total elongation y, is much less than unity, using equation (3) with the maximum load achieved is not valid and a correction factor must be applied. By calculating the maximum bending moment obtainable under the tensile yield stress (σ_{YT}) for a particular y, the ratio σ_{MAX}/σ_{YT} was determined by Burstein et al. By conducting bending and tension tests, they found bone to have a γ of 0.29 and σ_{MAX}/σ_{yt} of 1.56 for square cross-section beams. Several other authors [6, 7, 9] have used this factor to correct for significant plastic behavior when calculating bending strength of cortical bone by dividing elastic beam theory ultimate strength based on maximum load by 1.56. Synthetic bone materials tested in this study were considered linear elastic and the bending strength was calculated by the 0.2% offset method. This is a conservative measure of strength which is desired for our application. Using the 0.2% offset method is also appropriate for determining strength of bone substitute materials to be used in ballistic testing since the epoxy based materials are likely to exhibit less plastic deformation after yield at high strain rates.

Sample testing for fracture toughness was performed in three-point-bending per ASTM D5045-99 (Standard Test Methods of Plane-Strain Fracture Toughness and Strain Energy Release Rate of Plastic Materials), using the same sample sizes, test configuration, and displacement rate as for the three-point-bending tests described above. Sample dimensions were chosen to be representative of human ribs as for other three-point-bending and compression tests. Bending was again chosen as the most representative test mode keeping in mind application to ballistic and blast testing of a rib cage in a physical HSTM. Specimens for fracture toughness testing were notched by cutting through half the width with a 0.5 mm thick diamond blade at 3000 rpm on an automatic linear precision saw. The center of the loading nose was aligned with the notch to initiate fracture at the crack tip. K_{Q} was calculated from the following equation as described in ASTM D5045.

$${K}_{Q} = \frac{( {P}_{Q} )}{{TW}^{1 / 2}} \cdot f ( a / W ) \qquad ( 6 )$$

where:

$$f ( a / W ) = \frac{6 {( a / W )}^{1 / 2} [ 1.99 - a / W ) \\ ( 1 - a / W ) ( 2.15 - 3.93 a / W + 2 / 7 {a}^{2} / {W}^{2} ) ]}{( 1 + 2 a / W ) {( 1 - a / W )}^{3 / 2}}$$

In equation (6) P_{Q} is the maximum load applied to the sample, t is the specimen thickness, W is the specimen width, and a is the notch length. All sample dimensions were measured with a digital caliper of accuracy ±0.005 mm. The ASTM restriction on specimen thickness for a true K_{IC} measurement is t≧2.5(K_{Q}/σ_{ys})² which held true for all tests of the synthetic bone materials. Standard D5045 suggests performing uniaxial tension tests and using maximum load from these tests as σ_{ys}. In this study, the average 0.2% offset yield stress from the three-point-bending tests of unnotched samples was used instead. The minimum thickness for true K_{IC} measurement was calculated to be 1 mm for neat epoxy samples, 5.7 mm for epoxy plus milled fiberglass samples, and 7.1 mm for samples of epoxy with a fiberglass sleeve. Actual sample thicknesses for these three types of bone substitute material were 6.56±0.035 mm, 6.65±0.11 and 864±0.38 mm, respectively, for neat epoxy with milled fiberglass, and epoxy with a fiberglass sleeve running lengthwise along each specimen. Therefore, specimen dimensions complied strictly with the ASTM standard for measurement of plane strain fracture toughness and conditional fracture toughness, K_{Q}, as calculated in equation (6) is a valid K_{IC}. Two of the samples with fiberglass sleeves showed evidence of plastic behavior and peak loads were in the plastic range. For these samples, the load used for calculation of K_{IC} was the maximum load within 5% linearity from a least squares fit of load vs. displacement data.

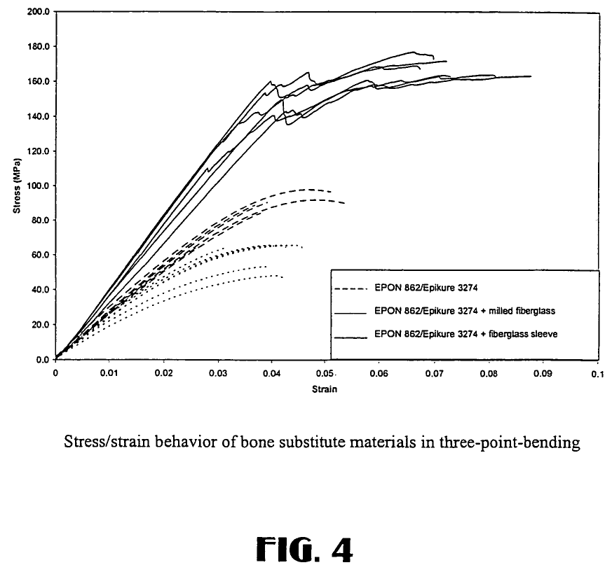

As a second way of determining strength and stiffness of the bone substitute materials to compare to bending test results, compression tests were performed per ASTM D695-02a (Standard Test Method for Compressive Properties of Rigid Plastics). Cylindrical samples were loaded longitudinally at a displacement rate of 2.6 mm/min (strain rate 1.5×10⁻s⁻¹) between platens made of hardened steel (FIG. 4b) on the same universal load frame used for three-point-bending and fracture tests. Test specimen diameter was 14 mm for neat epoxy and epoxy with milled fiberglass, 15 mm for samples with the outer biaxial sleeve. A length-to-diameter aspect ratio of 2:1, as suggested by standard D695, was used for all samples including neat epoxy, epoxy with milled fiberglass in volume, and epoxy with a fiberglass sleeve. D695 recommends a loading rate of 1.3 mm/min (0.75×10⁻³ s⁻¹) which can be increased after yield to run ductile materials to failure. Rather than use two different rates for the compression tests, 2.6 mm/min (1.5×10⁻³ s⁻¹) was chosen for convenience. Although the epoxy samples are expected to be strain rate sensitive, the behavior should not change significantly from 0.75×10⁻³ to 1.5×10⁻³ s⁻¹. The fiberglass sleeve was oriented lengthwise over the cylindrical samples. Stress was calculated as the applied load divided by cross-sectional area, strain as the load frame crosshead displacement divided by initial sample length. The materials were assumed to be linear elastic and strength was calculated as the 0.2% offset yield strength. Young's modulus the least squares fit of stress vs. strain data in the linear range.

Test results are summarized in Table 2 below:

TABLE 2
Low strain rate Mechanical testing summary of bone substitute materials.

| | Bending | | Bending | | Fracture | | Compression | |
|---|---|---|---|---|---|---|---|---|
| | Modulus | | Strength | | Toughness | | Modulus | |
| | (GPa) | | (MPa) | | MPa-m^{1/2} | | (GPa) | |
| Sample | MEAN | STDEV | MEAN | STDEV | MEAN | STDEV | MEAN | STDEV |
| EPON 862/Epikure 3274 | 2.6 | 0.1 | 72.9 | 4.9 | 1.3 | 0.5 | 2.6 | 0.1 |
| EPON 862/Epikure 3271 + milled fiberglass | 2.1 | 0.3 | 42.3 | 6.4 | 1.9 | 0.3 | 2.0 | 0.2 |
| EPON 862/Epikure 3274 + fiberglass sleeve | 3.7 | 0.3 | 143.8 | 14.0 | 6.4 | 0.7 | 2.6 | 0.3 |

| | | | | |
|---|---|---|---|---|
| Target Value | 9.5 | 126.7 | 6.5 | 5.3 |

FIG. 4 is a graph showing stress vs. strain data for three-point-bending tests of the bone substitute materials considered—neat epoxy (EPON 862/Epikure 3274), epoxy with milled fiberglass in volume, and epoxy with a fiberglass sleeve embedded at the outside of the sample. Ultimate bending strengths (mean±1 standard deviation of these materials were 72.9±4.9, 42.3±14.0 MPa, respectively, for neat epoxy, epoxy with milled fiberglass, and epoxy with a fiberglass sleeve running lengthwise along each specimen. Adding milled fiberglass in volume decreased the strength of the epoxy by 42%, while addition of a woven fiberglass sleeve increased the strength by 97%. The reason for the decrease in strength with milled fiberglass was not investigated thoroughly, but is typically due to poor adhesion between fibers and epoxy or overfilling the epoxy with fiberglass. The fiberglass sleeve increased the bending strength of nest epoxy to 13% over the target value of 126.7 MPa extracted from the published data at low strain rates. Examination of the samples revealed that failure initiated at the bottom surface which is in tension during three-point-bending tests. Test bars with the fiberglass sleeve fail in the epoxy without breaking completely through the sleeve.

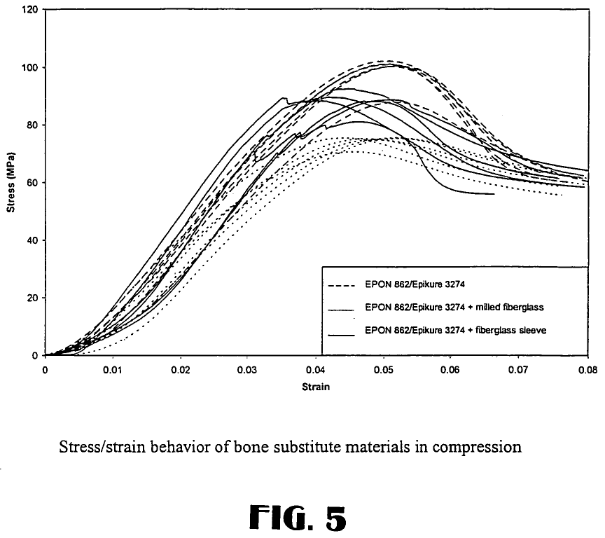

FIG. 5 is a graph of the results of synthetic bone compression tests. Ultimate strength mean and standard deviation was calculated for 6 samples of each material type: 88.0±3.9, 63.5±1.7 and 79.7±6.4 MPa for, respectively, neat epoxy, epoxy with milled fiberglass, and epoxy with a fiberglass sleeve running lengthwise along each cylindrical specimen. Compression strength of the epoxy was not changed as dramatically as bending strength by addition of fiberglass. Ultimate strength was reduced 18% by addition of milled fiberglass and reduced 10% by addition of the fiberglass sleeve. As expected, the fiberglass sleeve does not strength samples in compression and the reduction in strength can be accounted for by the increased diameter used in calculation of stress. The biaxial fiberglass sleeve was chosen to increase bending strength, which is most important for application to a rib cage under ballistic impact or blast. Published data suggest human cortical bone is strongest in compression. Compressive strength is reported to be 54% higher than tensile and 27% higher than other published data of bending strength from cadavers aged 20-40 years. Test results from this study show that compressive strengths of the neat epoxy and epoxy/milled fiberglass composites considered are greater than bending strengths of the same materials in bending tests. Bending strength is of greatest importance for use of the synthetic bone materials in ballistic and blast testing of the HSTM. Compression tests were conducted mainly as an alternative way of evaluating Young's modulus for comparison to bending tests. Addition of a fiberglass sleeve to the base epoxy significantly increased the bending strength, matching that of human cortical bone tested at low strain rates to within 13%.

In bending, Young's moduli (mean±standard deviation) of samples of neat epoxy, epoxy with milled fiberglass in volume, and epoxy with a fiberglass sleeve were 2.6±0.1, 2.1±0.3 and 3.7±0.3 GPa, respectively. Data from bending tests of the sleeve-reinforced specimens show a small inflection point at approximately 0.015 strain for each sample, most likely due to shifting or bending of the sleeves. The modulus for each of these samples was calculated over a range of stress from 40-100 MPa which includes the inflection point. Modulus was also calculated using the portions of each curve on either side of the inflection point. Slopes of these portions were within 2% of the entire slope from 40-100 MPa for each sample showing that the inflection point does not significantly influence the calculation of Young's modulus. In compression, Young's moduli of neat epoxy, epoxy with milled fiberglass, and epoxy with a fiberglass sleeve running lengthwise along each cylindrical specimen were, respective, 2.6±0.1, 2.0±0.2 and 2.6±0.3 GPa. The stiffness of samples of neat epoxy and epoxy with milled fiberglass were found to be similar when comparing bending tests and compression tests. In both modes, adding milled fiberglass proved to be detrimental to stiffness, reducing to modulus by approximately 20%. Again, for filled polymers, this is generally attributed to poor adhesion between epoxy and fibers or too great a volume fraction of fibers. In compression, addition of a fiberglass sleeve to neat epoxy had no effect. However, addition of the sleeve increased the bending modulus by 42% on average bringing the bone substitute closer to the target value of 9.5 GPa. Therefore, fiberglass biaxial sleeves embedded near the outside of the samples significantly improve their stiffness in bending, but stiffness remains at only 39% of the target value extracted from published literature on human cortical bone.

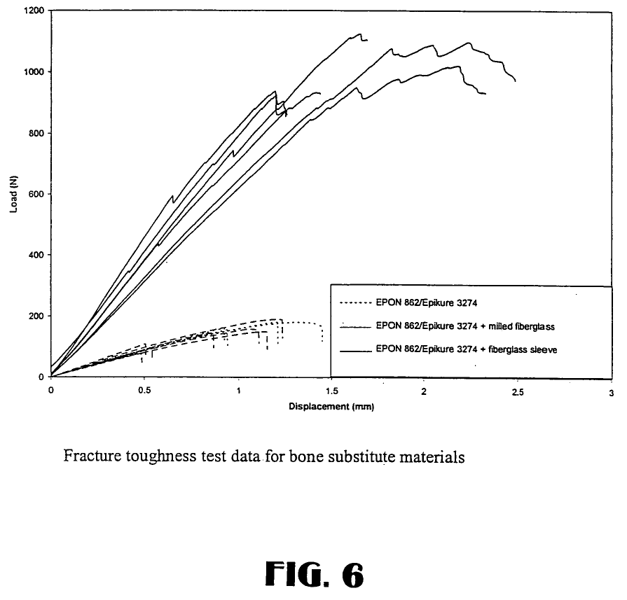

FIG. 6 shows load/displacement test plots for three-point-bending tests of notched synthetic bone test samples for determining fracture toughness. The plane strain fracture toughness K_{IC}, was calculated as described in ASTM D5054 for bending samples. The mean±one standard deviation for 6 samples of each bone substitute material (EPON 862/Epikure 3274 with milled fiberglass, EPON 863/Epikure 3274 with fiberglass biaxial sleeve) were 1.3±0.5, 1.9±0.3 and 6.4±0.7 MPa-m^{1/2}, respectively. The addition of milled fiberglass resulted in an average increase in the fracture toughness of 50% over neat epoxy. The addition of fiberglass sleeving to the neat epoxy resulted in an increase in fracture toughness of 500% matching the target value from the literature very closely. For all specimens tested, fracture initiated at the crack tip and traveled through the sample. Neat epoxy and epoxy with miller fiberglass samples fractured in a brittle fashion with the crack propagating all the way through the sample, while the crack formed in the samples with fiberglass sleeves was arrested prior to fracture. There was a large variation in the published data on fracture toughness of human bone (see Table 1). This is due in part to sensitivity of fracture toughness testing to several parameters including sample thickness, notch length, notch geometry and test mode (bending tension). Although notch geometries of the epoxy and epoxy-fiberglass composite samples were not studied in detail, test results are consistent with relatively small standard deviations.

Overall, the addition of biaxial fiberglass sleeving to the base epoxy (EPON 862/Epikure 3274) improved the mechanical properties—stiffness, strength, and fracture toughness—of the synthetic bone, more closely matching published data on bone properties at low strain rate (Table 2). The greatest improvement was made increasing the strength and fracture toughness. Bending strength was 13% higher on average than the literature target value and fracture toughness was within 2% of the literature target value on average with addition of the fiberglass sleeve. The sleeves improved the stiffness of the epoxy, but Young's modulus in bending for sleeved samples was still 61% lower on average than the target value. However, from the standpoint of impact testing, the more important properties are bending strength and facture toughness.

Bonding a fiberglass sleeve to the outside of the samples significantly increased their bending stiffness, bending strength, and fracture toughness. The fiberglass sleeves increased Young's modulus in bending of the epoxy by 42%, resulting in a value 30% of the target value for human bone at low strain rate. Addition of a fiberglass sleeve increased the bending strength of the epoxy by 97%, matching the target value from the literature within 13%. Fiberglass sleeves increased the fracture toughness of the epoxy by 500%, resulting in toughness almost identical to the target value.

While the above description contains many specifics, these specifics should not be construed as limitations of the invention, but merely as exemplifications of preferred embodiments thereof. For example, while the invention is advantageously used with regard to impacts from high velocity projectiles or explosive blasts, other types of impacts, such as those encountered in vehicle collisions, falls, impacts from objects sufficiently massive to cause injury even at less than ballistic velocity, are considered within the purview of the invention. Those skilled in the art will envision many other embodiments within the scope and spirit of the invention as defined by the claims appended hereto.

What is claimed is:

1. A bone substitute for use in impact testing of a structure simulating the human body which comprises:
a) a member fabricated from epoxy resin; and
b) a fiberglass sheath embedded in an outer circumferential portion of the member.

2. The bone substitute of claim 1 having a bending strength of at least about 125 MPa.

3. The bone substitute of claim 1 having a bending strength of at least about 140 MPa.

4. The bone substitute of claim 1 having a fracture toughness of at least about 5.0 MPa-m^{1/2}.

5. The bone substitute of claim 1 having a fracture toughness of at least about 6.0 MPa-m^{1/2}.

6. The bone substitute of claim 1 having a bending modulus of at least about 3.5 GPa.

7. The bone substitute of claim 1 having a compression modulus of at least about 2.5 GPa.

8. The bone substitute of claim 1 wherein the fiberglass sheath is a braided or woven sheath.

9. The bone substitute of claim 1 having a bending strength of at least about 125 Mpa, a fracture toughness of at least about 5.0 MPa-m^{1/2}, a bending modulus of at least about 3.5 Gpa, and a compression modulus of at least about 2.5 GPa.

10. A method for determining the suitability of a material for use as a bone substitute for impact testing of a structure simulating the human body, the method comprising:
a) determining the bending strength of the material;
b) determining the fracture toughness of the material;
c) comparing the bending strength and fracture toughness of the material with predetermined values of bending strength and fracture toughness of human bone.

11. The method of claim 10 further comprising the step of determining whether the bending strength and fracture toughness are within about 20% of the corresponding predetermined values for human bone.

12. A method for simulating the effect of an impact upon a human body comprising:
a) providing a structure including at least one bone substitute member fabricated from epoxy resin and having a fiberglass sheath embedded in an outer circumferential portion of the member;
b) subjecting the structure to an impact; and
c) observing the effect of the impact upon the structure.

13. The method of claim 12 wherein the at least one bone substitute member includes one or more simulated human rib, sternum or vertebrae shaped and configured like those of a human being.

14. The method of claim 13 wherein the structure comprises simulated layers of fat and skin.

15. The method of claim 14 wherein the structure further comprises a gelatin layer.

16. The method of claim 15 wherein the structure further comprises a sensor array positioned within the gelatin layer.

17. The method of claim 12 wherein the impact is from a ballistic projectile or an explosive blast.
